(19) United States
(12) Patent Application Publication
(10) Pub. No.: US 2011/0056101 A1
(43) Pub. Date: Mar. 10, 2011

(54) SET OF COLLECTABLE, SUPERIMPOSABLE CARDS

(76) Inventor: Anselmo Basso, Torino (IT)

(21) Appl. No.: 12/681,742

(22) PCT Filed: Oct. 3, 2007
(86) PCT No.: PCT/IB08/54057

§ 371 Date: Nov. 22, 2010

(30) Foreign Application Priority Data
Oct. 5, 2007 (EP) 07425618.1

(51) Int. Cl. A63F 1/02; G09F 1/00

(52) U.S. Cl. 40/124.191

(57) ABSTRACT

A set of collectable cards includes base cards bearing background images and accessory cards congruent with the base cards, which bear one or more images that are complementary to the background images and are distributed on a transparent area, and which can be superimposed on the base cards to form composite images. The accessory cards have an adhesive material for temporary connection to the base cards or to other accessory cards in a superimposed condition and define, in combination with another card in an aligned, superimposed condition, shaped portions for the separation of the cards from one another.

The present invention relates to a set of collectable, superimposable cards, of the type defined in the preamble to claim 1.

Printed, collectable cards bearing images of real or imaginary people, animals or backgrounds are very widespread particularly amongst children and adolescents. Predetermined numbers of different cards form a collection and enable role-play games to take place, optionally in combination with game boards or similar accessories.

WO 03/057328 discloses superimposable playing cards a collection of which comprises base cards bearing background images and transparent accessory cards of matching shape and size which bear one or more images complementary to the background images and which can be superimposed on a predetermined base card to form one or more composite images. Cards that are superimposed on one another are held together by adhesion between the connecting surfaces with the use, for example, of the effect of electrostatic attraction between the surfaces.

However, these cards are expensive and have imperfections and difficulties of use which render collection and playing impractical particularly because it is necessary to provide the card with films that are sensitive to electrostatic attraction on both faces of the accessory cards, increasing their thickness and ultimately the thickness of the stack of cards representing a complete image.

Moreover, they are difficult to separate and continual separation by unskilled players causes deterioration of the cards that are most used, particularly at the edges in the regions of the peripheral corners of the card.

The object of the present invention is to provide improved collectable, superimposable cards with better adhesion characteristics and at the same time easier separation, so that their useful life is extended, enabling different composite images to be made up and taken apart extremely easily.

Further advantages and characteristics of the present invention will become clear from the following detailed description relating to the appended drawings which are provided purely by way of non-limiting example and in which:

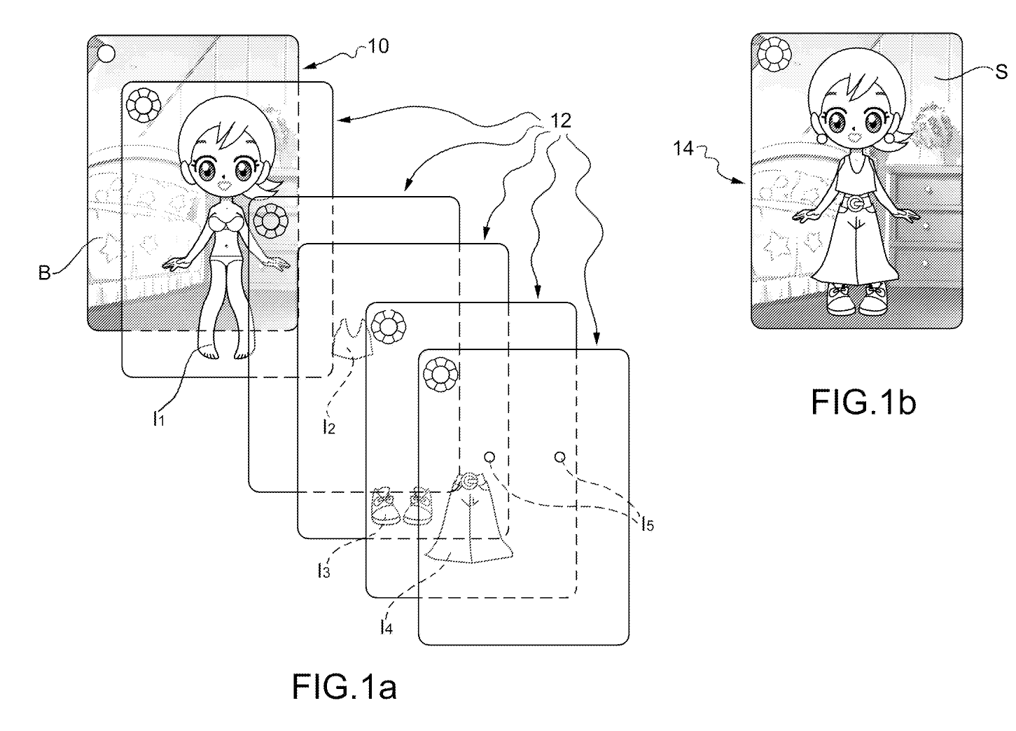

FIG. 1a and 1b are schematic views of collectable, superimposable cards,

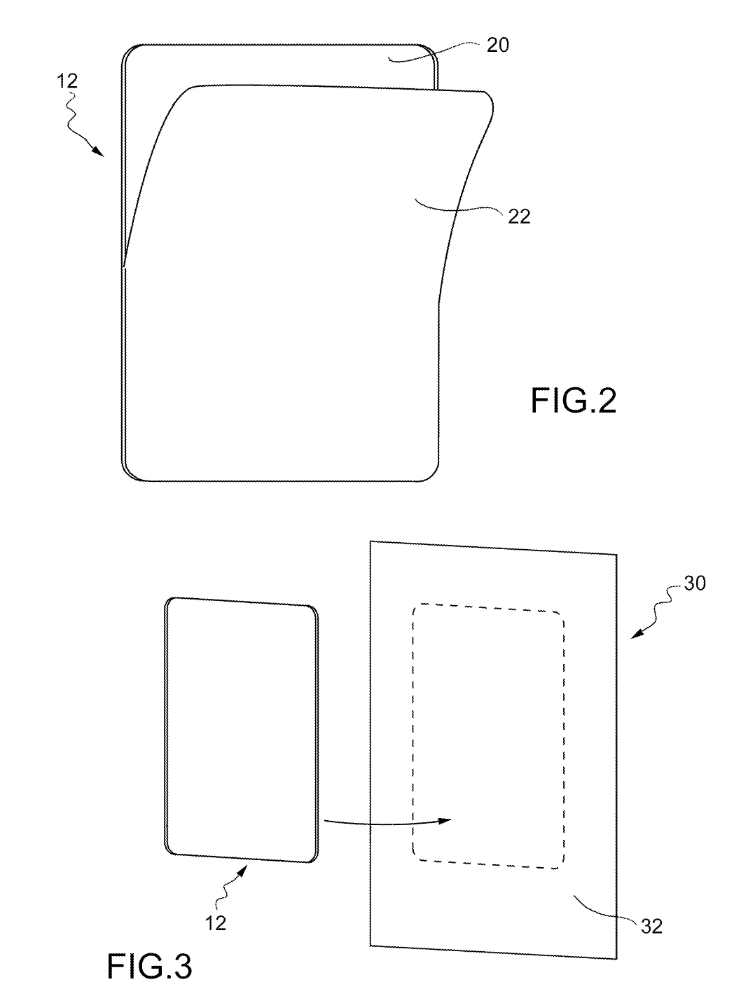

FIG. 2 is a schematic view of an accessory collectable card provided with a film for protecting an adhesive layer,

FIG. 3 is a schematic view of an accessory collectable card mounted in a suitable collecting album,

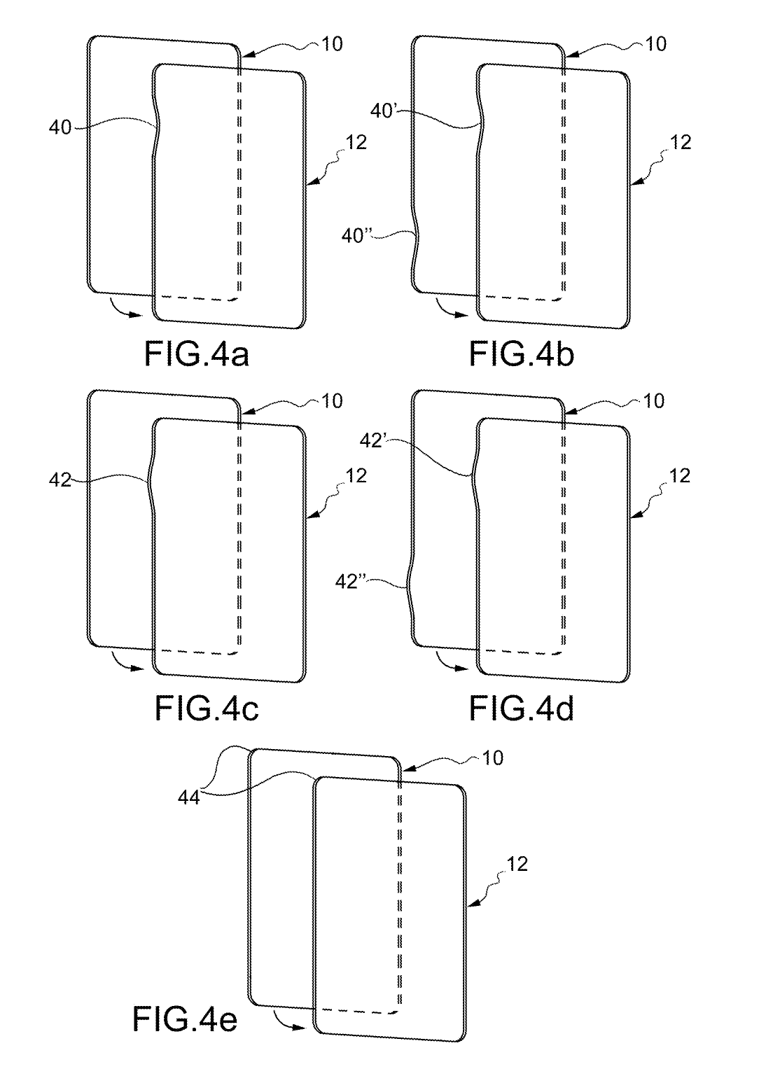

FIGS. 4a-4e are schematic views of cards provided with separation means according to the invention.

The present invention relates to a set of collectable, printed cards bearing superimposable images, comprising a plurality of generally opaque base cards 10 bearing background images or scenes and a plurality of at least partially transparent accessory cards 12 which bear images complementary to the background images and which can be superimposed on one or more predetermined base cards 10 to form a completed multi-layered card 14 bearing a composite image.

A base card 10 may be made of various materials and in various shapes. For example, it may be transparent, made of PVC or PET, like the cards known by the trade name Lamincard®, or of card. The dimensions of the cards may vary but are preferably equivalent to those of the accessory cards 12. The image printed on the base card may be, for example, a person, an object, or a landscape which can be enhanced by the addition of further components as a result of the superimposition of one or more accessory cards.

An accessory card 12 is made of transparent material and is thinner than the base cards. The image or images printed on the accessory cards represent accessories or elements which are intended to enhance the image of a base card, for example, garments for a person, armour for warriors, elements of a landscape, components of a motor vehicle, etc.

A plurality of accessory cards 12 can be placed on a single base card 10 to produce a “completed” card 14 bearing a composite image.

In the embodiment shown in the drawings, a scene B of a room is shown on the base card 10 and the accessory cards 12 bear depicted image elements I₁-I₅ which can be superimposed on the background image B and which represent, respectively, (in the order in which they are superimposed) an unclothed person (I₁), a jumper (I₂), a pair of shoes (I₃), a pair of trousers (I₄), and a pair of ear-rings (I₅). The composite image S depicted by the completed card 14 thus represents a fully clothed person set in the room.

A base card 10 made of PVC, PET, or card typically has a thickness of between 300 and 400 microns and is generally printed by offset technology in four-colour printing with a first, translucent printing, a subsequent opaque white printing in register under the four-colour printing, a further opaque white printing step (to improve the cover), and subsequent four-colour printing. The back of the card is printed with a glossy UV film with a solid background. The thickness of the material may vary but the base card is preferably thicker than the accessory cards.

An accessory card 12 made of transparent PVC or PET typically has a thickness of between 200 and 300 microns and is generally colour-printed by four-colour printing with a first translucent printing and subsequent opaque white printing in register under the four-colour printing. It is then rendered adhesive by means of an adhesive material or a resin.

A completed card 14 is a multi-layered card formed by a base card 10 and a variable number of accessory cards 12, up to a predetermined maximum, in a stacked configuration. It can be taken apart and re-assembled by combining different accessory cards 12, provided that they are adapted to represent a composite image S. Each layer represents one or more image elements I that can be added to the subject B shown on the base card and which help to complete it, for example, to clothe or adorn a person, or to enhance a landscape with elements, according to the tastes of the player or the rules of the game.

The stacked configuration of cards, in which different accessory cards 12 are superimposed on one another and on a base card 10 at the bottom is temporarily held together by connection between the cards by adhesive means such as adhesives or synthetic resins, or by electrostatic effect, in a manner such that the cards can be separated and joined together countless times.

In particular, each accessory card 12 is rendered adhesive by the application of an adhesive film to the back 20 of the card, either over the entire rear surface of the card which is to adhere to another card, for optimally transparent adhesive films, or in predefined regions corresponding to the printed region (for example, image elements or frame) so that a film with poor transparency properties is not visible on the transparent surface of the card.

In the first case, the adhesive layer is applied by the spreading of a uniform layer of adhesive or resin on a roll of PVC or PET (rolling) with the use of a plasticizer. Since a resin is a ductile material formed by crystals which, with heat, adhere to the substrate material on which the resin is spread, becoming a single body therewith, it is advantageously not prone to wearing out or being transferred to the surfaces to which it adheres as an adhesive. A special technique has been developed for the production of cards provided with a resin-based adhesive layer, in which the resin is melted in a tank, collected and sprayed onto rolls of PVC or PET in order then to be spread at 60° C., calendered and dried (polymerized) for 48 hours prior to the printing step. Specifically, a PET card is preferred for the spreading of resin because of the higher glass transition point of PET, which is above 70° C., at which temperature the resin is spread. The roll is then printed and cut to create the accessory playing cards.

In the second case, the adhesive layer is applied by a silk-screen printing process for which the adhesive film is spread in register under the white (or in any case opaque) regions that are present on the previously offset-printed sheet, by means of a common mask also used for the printing of the background layer of the image.

In both cases, a removable, thinner (for example 120 microns), transparent, PVC protection and release film 22 is arranged to protect the layer of adhesive material applied to the back of the card to permit packaging operations and at least until the occasion of the first use of the card.

The preferred adhesive material is an adhesive or resin of the “stick and release” type, that is, which allows the cards to be joined and separated countless times without appreciable loss of strength, except owing to inevitable but remediable accumulation of dirt. The adhesives and resins used can be regenerated, for example, by washing with a conventional detergent (water and soap) so that the surface on which the adhesive film has been spread can easily be cleaned when the adhesive effect has been lost owing to the picking-up of dust and dirt. The adhesive material is also such as not to leave traces on the fingers or other body parts of the player handling the cards or on surfaces to which the card is applied.

After the protective film has been removed, the card can be mounted in a suitable collecting album 30 provided with pages 32 of glossy paper having the function of a supporting substrate.

The base cards and the accessory cards define, in combination with other cards in an aligned, superimposed condition, means for their separation, comprising a disalignment of at least one peripheral portion of the corresponding sides of a pair of adjacent superimposed cards.

For example, and with reference to FIGS. 4a-4e, the disalignment may be a concave portion 40 formed in one side of only one of two superimposed cards, or a pair of offset concave portions 40′ and 40″ formed in corresponding sides of a pair of adjacent superimposed cards.

Alternatively, the disalignment may be a convex portion 42 formed on one side of only one of two superimposed cards, or a pair of offset convex portions 42′ and 42″ on corresponding sides of a pair of adjacent superimposed cards.

In a variant, the disalignments may be represented by chamfers 44 of different radius of curvature at the corners of the card.

Cards that are intended for forming different layers of a completed card may have the above-mentioned disalignments on different sides (or corners) so as to facilitate their separation.

Naturally, the principle of the invention remaining the same, the forms of embodiment and details of construction may be varied widely with respect to those described and illustrated purely by way of non-limiting example, without thereby departing from the scope of protection of the present invention defined by the appended claims.

1. A set of collectable cards comprising a plurality of base cards bearing background images and a plurality of accessory cards congruent with the base cards, which bear one or more images that are complementary to the background images and are distributed on a transparent area, and which can be superimposed on the base cards to form composite images,
wherein the accessory cards comprise adhesive means for temporary connection to the base cards or to other accessory cards in a superimposed condition and define, in combination with another card in an aligned, superimposed condition, means for the separation of the cards.

2. A set of collectable cards according to claim 1, in which the means for the separation of the cards comprise a disalignment of at least one peripheral portion of corresponding sides of a pair of adjacent superimposed cards.

3. A set of collectable cards according to claim 2, wherein the disalignment includes a concave portion formed on one side of a card.

4. A set of collectable cards according to claim 3, wherein the means for the separation of the cards comprise offset concave portions on corresponding sides of a pair of adjacent superimposed cards.

5. A set of collectable cards according to claim 2, wherein the disalignment includes a convex portion formed on one side of a card.

6. A set of collectable cards according to claim 5, wherein the means for the separation of the cards comprise offset convex portions on corresponding sides of a pair of adjacent superimposed cards.

7. A set of collectable cards according to claim 2, wherein the disalignment includes chamfers with different radius of curvature at respective corresponding corners of adjacent superimposed cards.

8. A set of collectable cards according to claim 1, wherein the adhesive means include an adhesive substance adapted to allow the cards to be joined and separated on multiple occasions and washable with a conventional detergent.

9. A set of collectable cards according to claim 8, wherein the adhesive substance is distributed on selected areas of the surface of the card being adhered to another card.

10. A set of collectable cards according to claim 9, in which the selected areas correspond to image areas of the card.

11. A set of collectable cards according to claim 8, wherein the adhesive substance is can be applied by silk-screen printing through a common mask also used for an operation for the printing of an opaque background layer of the image.

12. A set of collectable cards according to claim 1, wherein the adhesive means include a synthetic resin adapted to allow the cards to be joined and separated on multiple occasions and washable with a conventional detergent.

13. A set of collectable cards according to claim 12, wherein the resin is distributed uniformly on a that surface of the card which is to adhere to another card.

14. A set of collectable cards according to claim 13, wherein the resin is applied in a layer to the surface of the card which is to adhere to another card, by rolling.

15. A set of collectable cards according to claim 1, comprising a booklet for the collection of the cards provided with glossy paper pages having the function of a supporting substrate for the accessory cards after the removal of a protective film for protecting the adhesive means until the occasion of the first use of the card.
